(19) United States
(12) Patent Application Publication
(10) Pub. No.: US 2011/0317770 A1
(43) Pub. Date: Dec. 29, 2011

(54) DECODER FOR MULTIPLE INDEPENDENT VIDEO STREAM DECODING

(75) Inventors: Ray E. Lehtiniemi, Calgary (CA); David J. Lewis, Calgary (CA)

(73) Assignee: Worldplay (Barbados) Inc., Bridgetown (BB)

(21) Appl. No.: 12/822,870

(22) Filed: Jun. 24, 2010

(51) Int. Cl. H04N 7/12

(52) U.S. Cl. 375/240.25; 375/240.01; 375/E07.027

(57) ABSTRACT

By using a single timestamp for both video streams, existing video processing frameworks can be used in a decoder to render a single output video where the detail from one stream is combined with the carrier from the other stream. In one embodiment, the carrier stream carries the time frame and time frame offsets are used to instruct the decoder as to the relative frame position in the detail stream. The encoding process inserts data into the transmission related to housekeeping chores on a frame by frame basis. The inserted data pertains to items such as carrier timestamping, detail offset timestamping; encryption, compression levels for the carrier and detail streams. In one embodiment, each of the streams is individually buffered and algorithms are used to match each carrier frame with a corresponding detail frame. Seeking is accomplished by identifying a desired carrier stream I-frame and then matching that I-frame with a proper I-frame of the detail stream.

### CROSS-REFERENCE TO RELATED APPLICATIONS

This application is related to commonly owned patent application SYSTEMS AND METHODS FOR HIGHLY EFFICIENT VIDEO COMPRESSION USING SELECTIVE RETENTION OF RELEVANT VISUAL DETAIL, U.S. patent application Ser. No. 12/176,374, filed on Jul. 19, 2008, Attorney Docket No. 54729/P012US/10808779; SYSTEMS AND METHODS FOR DEBLOCKING SEQUENTIAL IMAGES BY DETERMINING PIXEL INTENSITIES BASED ON LOCAL STATISTICAL MEASURES, U.S. patent application Ser. No. 12/333,708, filed on Dec. 12, 2008, Attorney Docket No. 54729/P013US/10808780; VIDEO DECODER, U.S. patent application Ser. No. 12/638,703, filed on Dec. 15, 2009, Attorney Docket No. 54729/P015US/11000742 and concurrently filed, co-pending, commonly owned patent applications SYSTEMS AND METHODS FOR HIGHLY EFFICIENT COMPRESSION OF VIDEO, U.S. patent application Ser. No. ______, Attorney Docket No. 54729/P016US/11000746; A METHOD FOR DOWNSAMPLING IMAGES, U.S. patent application Ser. No. ______, Attorney Docket No. 54729/P017US/11000747; SYSTEMS AND METHODS FOR CONTROLLING THE TRANSMISSION OF INDEPENDENT BUT TEMPORALLY RELATED ELEMENTARY VIDEO STREAMS, U.S. patent application Ser. No. ______, Attorney Docket No. 54729/P019US/11000749; SYSTEMS AND METHODS FOR ADAPTING VIDEO DATA TRANSMISSIONS TO COMMUNICATION NETWORK BANDWIDTH VARIATIONS, U.S. patent application Ser. No. ______, Attorney Docket No. 54729/P020US/11000750; and SYSTEM AND METHOD FOR MASS DISTRIBUTION OF HIGH QUALITY VIDEO, U.S. patent application Ser. No. ______, Attorney Docket No. 54729/P021US/11000751 all of the above-referenced applications are hereby incorporated by reference herein.

### TECHNICAL FIELD

This disclosure relates to decompression decoders and more specifically to decoders for decompressing multiple independent video steams and for combining the decompressed video into a unified video stream.

### BACKGROUND OF THE INVENTION

The problem is to decode (decompress) two independent video streams, which, in some situations, can be combined together. A number of challenges exist, both with respect to transferring the video from the encoder to the decoder as well as with fitting the decoder into existing frameworks. The existing frameworks, such as Microsoft Direct Show, G-Streamer from Linux, are predicated upon receipt of a monolithic compressed video stream. For reasons discussed in the above entitled co-pending application titled SYSTEMS AND METHODS FOR HIGHLY EFFICIENT COMPRESSION OF VIDEO situations exist wherefrom compression efficiency the video stream is divided into a Detail portion and a Carrier portion which, while locked together temporally are actually independent streams compressed separately. While the Detail and Carrier portions are, in fact, temporally related, they are transmitted in a manner, (as discussed in above-identified co-pending patent application titled SYSTEMS AND METHODS FOR CONTROLLING THE TRANSMISSION OF INDEPENDENT BUT TEMPORALLY RELATED ELEMENTARY VIDEO STREAMS) so as to not be tightly synchronized with each other.

The existing framework, however, assumes that every frame of video has one timestamp on it. In the dual transmission scenario each video stream has its own timestamp and while they are generally close to each other (typically within two or three frames of each other) they are not identical. This then leads to two primary challenges; namely, 1) properly packaging the data and moving it from the encoder across the network to the decoder within the existing framework, and 2) dealing with the fact that at the decoder every frame of data actually has twice size.

One initial approach is to solve these problems at the transport level by taking advantage of the fact that transports have concurrent data and video capability. However typical multi-media frameworks are not set up to have two independent video decode processes occurring at the same time. None of the existing video transport/processing frameworks have the ability to synchronize and combine to different video streams.

Another set of problems exists when seeking is required. Seeking is the concept of changing the position in the movie that a viewer wishes to see. For example, jumping ahead in a movie is a form of seeking. Seeking presents a problem because in a compressed transmission every frame of data does not contain all of the data necessary to view that frame. Instead there are I-frames where an image is formed and then several frames (delta frames) where only changes to the I-frame are transmitted. Thus, seeking on every frame is impossible because the delta frames only contain partial information. The seeking problem is compounded because the carrier and detail streams are separate and have separate timing and thus do not line up.

### BRIEF SUMMARY OF THE INVENTION

By using a single timestamp for both video streams, existing video processing frameworks can be used in a decoder to render a single output video where the detail from one stream is combined with the carrier from the other stream. In one embodiment, the carrier stream carries the time frame and time frame offsets are used to instruct the decoder as to the relative frame position in the detail stream. The encoding process inserts data into the transmission related to housekeeping chores on a frame by frame basis. The inserted data pertains to items such as carrier timestamping, detail offset timestamping; encryption, compression levels for the carrier and detail streams. In one embodiment, each of the streams is individually buffered and algorithms are used to match each carrier frame with a corresponding detail frame. Seeking is accomplished by identifying a desired carrier stream I-frame and then matching that I-frame with a proper I-frame of the detail stream.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 presents an overview of a typical multimedia framework into which the decoder discussed herein may be deployed;

FIG. 2 depicts one embodiment of a video decoder according to aspects of the invention;

FIG. 3 depicts one embodiment of the merger device shown in FIG. 2;

FIGS. 4A through 4E show one embodiment of the memory layout of decoded video from buffers in SDRAM;

FIG. 5 illustrates one embodiment 50 of a secure memory scrambler diagram environment; and

FIG. 6 shows one of the 16 F blocks in one SP stage.

### DETAILED DESCRIPTION OF THE INVENTION

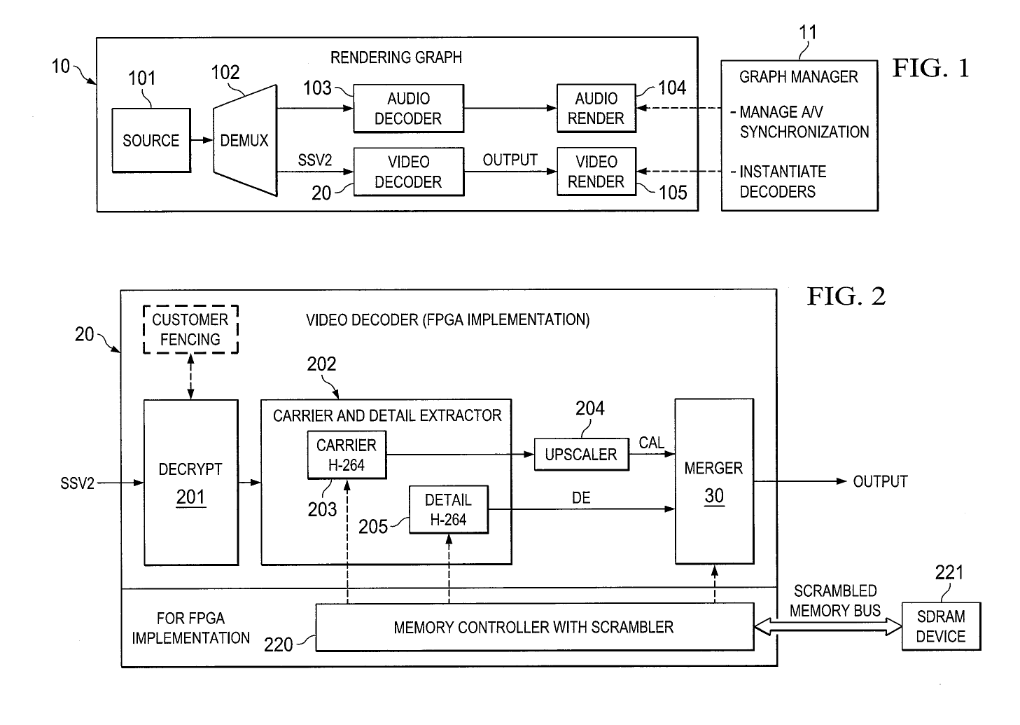

FIG. 1 presents an overview of a typical multimedia framework into which the decoder discussed herein may be deployed. Codecs (coder/decoder) are not typically standalone devices, but rather they are deployed into an existing multimedia framework. In the embodiment discussed herein, the framework is Microsoft DirectShow. The overall structure is that of rendering graph 11 managed by graph manager 11. The rendering graph does the bulk of the data processing, while the graph manager handles the setup, control, and shutdown processes.

The basic structure of rendering graph 10 is a directed graph of signal processing elements operating on one or more media streams. Several fundamental classes of elements are connected in typical patterns to achieve common multimedia processing goals, such as file playback. Source 101 is responsible for ingesting multimedia content from outside the rendering graph and injecting the obtained source media into the signal processing graph. The origin of the source media determines the specific source element used. For example, a local file would use a file reader source, while a streaming network server would use a streaming source element. Each such source element is designed to understand the particular network protocol in use from the origin of the data.

Demux 102, also commonly called a splitter, is responsible for taking a complete multimedia stream and decomposing it into a series of time-stamped single, or elementary, media streams. For example, a multimedia stream on a DVD might contain 12 elementary streams, consisting of: one video stream, three audio tracks (English, French and Spanish, etc.); and eight subtitle tracks (Chinese, German, etc.). The demux is responsible for extracting one or more elementary streams and sending them downstream for further processing and display. In this example, the video stream and English audio track might be extracted, while the other audio tracks and subtitle tracks are not used.

Audio decoder 103 is responsible for taking a small encoded audio stream and uncompressing it into a large raw PCM audio stream. It then passes this raw PCM stream on for rendering in conjunction with rendering of the video stream. Audio renderer 104 is responsible for taking a stream of PCM audio samples and converting them to audible sound, generally via the use of dedicated hardware such as a sound card.

Video decoder 20 is responsible for taking an encoded video stream and uncompressing it into a raw YUV video stream which is then passed along for rendering. In the embodiment being discussed, the input video from the demux is in a format known as SSV2, and the output is raw YUV video frames. Video renderer 105 is responsible for taking a stream of YUV video samples and converting them to a visible series of pictures, generally via the use of dedicated hardware such as a video card.

Graph manager 11 is responsible for controlling the creation, operation, and destruction of the rendering graph. During the operation phase, a key responsibility is to manage the audio/video synchronization between the two media streams. Generally, this is done by syncing the video stream to the audio stream through some combination of delaying, advancing, repeating or dropping of video frames. This is because the human ear is much more sensitive to discontinuities in the audio track than is the human eye to discontinuities in the video track.

FIG. 2 depicts one embodiment of video decoder 20 according to aspects of the invention. This embodiment is a hardware version but other decoders could be firmware or software. Not shown in FIG. 2 is support software which is not critical to the operation of the decoding process. This software includes driver software on the PC and firmware on the decoder hardware. These layers are used to coordinate the transfer of encoded and decoded video frames between the hardware decoder device and the rendering graph on the host PC. The software also performs a variety of standard housekeeping operations related to device.

Decrypt 201 (if encryption is used to protect the confidentiality of the file format) operates to decrypt the incoming video. The cipher operates in counter mode as defined in NIST SP-800-38a, Section 6.5 on page 15, which is hereby incorporated by reference. This mode allows decryption to begin at any point in the encrypted stream, as required for efficient support of seeking operations on the video stream. A 128 bit symmetric key is used for encryption and decryption as a fixed shared secret between the encoder and all decoders. The 128 bit initialization vector used for encryption and decryption is split into a 96 bit nonce and a 32 bit counter. The 96 bit nonce is required to be unique. As such, it is constructed from the following information: a unique identifier for the encoder used to create the file; the current time, in seconds, that the file was encoded; an incrementing counter of encodes performed using this encoder; and a random value. The incrementing encode counter is needed in case the encoder begins more than one encode job within a one second interval. The encoder id field is envisioned to have substructure which would allow for a very limited form of DRM, called “customer fencing”. The intent is to prevent content from one potential customer from being viewed by decoders given to other customers.

The nonce applies to all video packets in the video stream. Therefore, it is stored in the Configuration packet of the video stream, as discussed in the above-identified co-pending application entitled SYSTEMS AND METHODS FOR CONTROLLING THE TRANSMISSION OF INDEPENDENT BUT TEMPORALLY RELATED ELEMENTARY VIDEO STREAMS. The 32 bit counter is required to be unique. Each video packet has a separate counter constructed from the byte offset within the overall video stream of the first byte in that packet. The SSV2 format consists of two separate H.264 video streams, one called Carrier and one called Detail.

These separate streams are extracted and separated, as will be discussed, by extractor 202. Carrier separator 203 is a standard H.264 decoder which decodes the Carrier video frame into a YUV video frame a lower resolution than the Detail stream. Upscaler 204 uses a standard bilinear scaling algorithm, together with resolution information carried in the video stream, to resize the Carrier video frame to the same size as the Detail video frame.

Detail separator 205 is a standard H.264 decoder which decodes the detail video frame into a YUV video frame at a higher resolution than the carrier stream.

After both the Carrier and Detail video frames have been decoded, extracted, and scaled to the correct size, merger 30 is responsible for finding frames of video with the same timestamp and combining them to create the final output video frame.

To help protect the operation of the video decoder from scrutiny, all traffic on the memory bus between the FPGA video decoder logic and the SDRAM memory device is scrambled. Scrambler 220 is responsible for scrambling the data written to SDRAM 221, and unscrambling the data read back from the SDRAM. The SDRAM is used to hold video frame buffers and other working data required by the video decoder logic in the FPGA device.

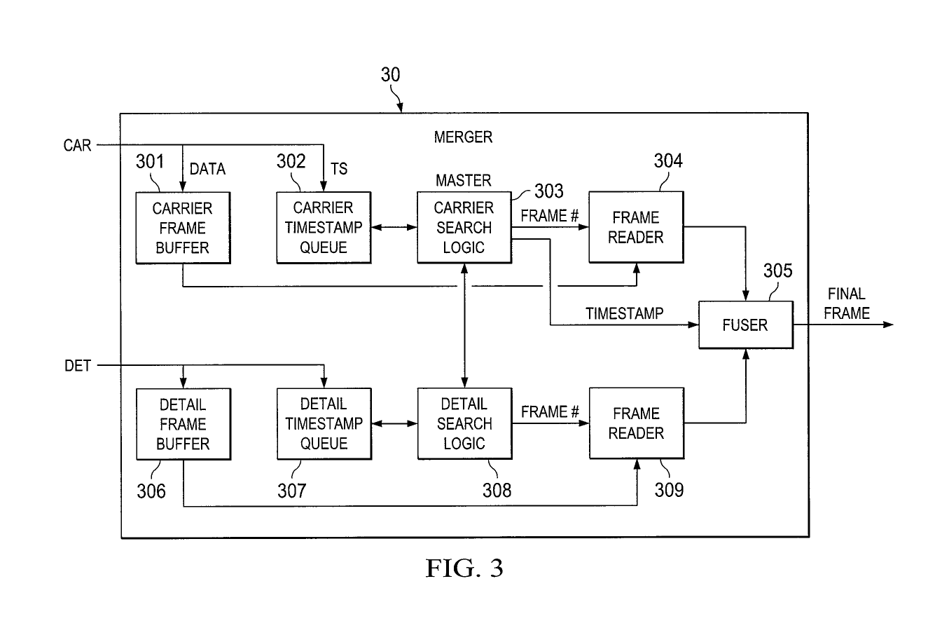

FIG. 3 depicts one embodiment of merger device 30 shown in FIG. 2. The purpose of the process performed by this device is to receive the processed Carrier and Detail frame streams to combine each individual Carrier frame with its corresponding Detail frame and output the final frames in proper display order.

Carrier frame buffer 301 receives each Carrier frame and writes the video data contained therein to an empty slot therein. Slots are made available for new frames once they are read out by the Carrier frame reader block (not shown). Carrier timestamp queue 302 writes the control data associated with the carrier portion of each frame as that frame is received to the next available entry in the Carrier timestamp queue. This control data includes such things as a pointer into the frame buffer, the frame timestamp, various flags, etc.

As each Detail frame is received, its video data is written to an empty slot in Detail frame buffer 306. Slots are made available for new frames once they are read out by the detail frame reader block. Detail timestamp queue 307 accepts the control data associated with each frame and it is written to the next available entry in the detail timestamp queue. This control data includes such things as a pointer into the frame buffer, the frame timestamp offset from the Carrier, various flags, etc. The Detail timestamp queue is managed by Detail search logic 308 which in turn is controlled by the Carrier search logic. Detail search logic 308 is responsible for searching through the Detail timestamp queue to find the Detail frame with the requested timestamp. Once found, the control information for this frame is then passed on to Detail frame reader 309. As part of the error handling, this logic also discards all “old” frames that are found in the Detail timestamp queue.

The Carrier timestamp queue is managed by carrier search logic 303 which is responsible for continually searching through the Carrier timestamp queue looking for the next Carrier frame to be sent out for display. Once found, this logic 303 then controls the other blocks used to locate the Detail frame, read the frames from memory, and combines them for output.

The Carrier search is based on the timestamp associated with each Carrier frame. However, provisions are also made to allow for the skipping of frames to deal with lost or late frames. After the next Carrier frame to be used is identified, the logic then enables Detail search logic 308 to search for the Detail frame with the matching timestamp. Once the Detail frame has also been identified, logic 303 passes the relevant control information on to Carrier frame reader 304 and to fuser 305 thereby enabling those functions.

Following the transmission of the frame from the fuser, logic 303 releases Detail frame buffer 306, Detail timestamp queue 307, Carrier buffer 301 and Carrier timestamp queue 301 and resumes searching of the Carrier timestamp queue for the next frame to be sent out. As part of the error handling, logic 303 also discards all old frames that are found in the Carrier timestamp queue.

Frame readers 304 and 309, once enabled by the Carrier search logic, reads the indicated Carrier or Detail frames from the respective frame buffers and feeds then to fuser 305. The fuser is responsible for adding together (or “fusing”) a Carrier and Detail frame, on a pixel-component basis. As the fusing is performed, the combined (or “final”) frame is output.

During encoding the pixel values for the Detail frames are biased about the mid-point of their full swing. This means that instead of the Detail pixel values going from 0 to +255, they go from −128 to +127. This allows the Detail pixel values to influence the Carrier pixel values in either direction (i.e., increase or decrease). Then fuser 305 simply adds together the Carrier and Detail pixel values and subtracts 128 from the result. This removes the mid-point bias that was in the Detail values. The pixel values are then clamped at their pixel bounds (i.e., any resulting pixel value<0 is made equal to 0, any value>255 is made equal to 255).

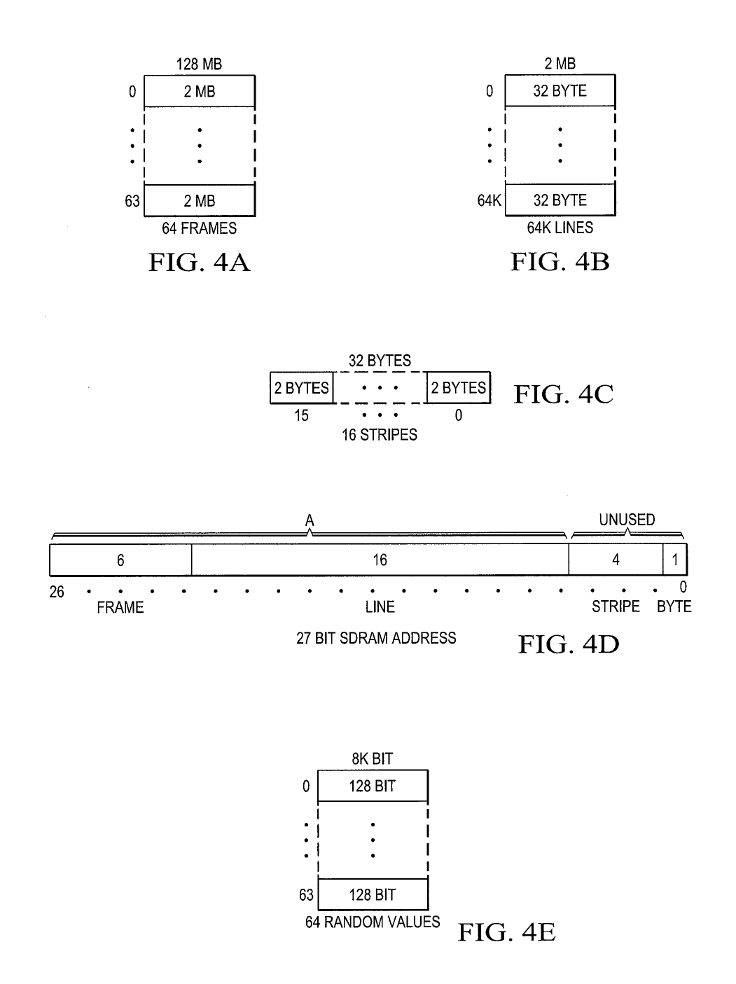

FIGS. 4A through 4E show one embodiment of the memory layout of decoded video from buffers in SDRAM. In one embodiment, the video decoder logic requires an SDRAM memory storage area (such as memory 221 (FIG. 3) connected by a memory bus. The contents of this bus can be viewed using an appropriate hardware device. The information thus gathered could be used to determine details about the operation of the video decoder. To prevent this, the contents of the memory bus, if desired, can be scrambled. As known from basic cryptography, an SP-Network is a substitution-permutation network. The high level structure is a cascade of an S-box which substitutes a different output value for a given input value, creating “confusion”. The S box is followed by a P-box which produces an output value by permuting the individual bits of the input value, creating “diffusion”. Any number of SP box pairs may be cascaded to increase the amount of confusion and diffusion created.

Maximal length sequences (M-sequences) are produced, as is well known, by iteration of a particular class of mathematical function. M-sequence generator functions have identical domain and range. For example, a 16 bit generator function has domain equal to range equal to 0.65535. Iteration of an M-sequence generator function produces two distinct cyclic patterns of values, depending on the initial value. Iteration from zero produces an infinite stream of zeros. In other words, zero is a fixed point of an m-sequence generator function. Iteration from a non-zero value produces a maximal length sequence. The term “maximal length” refers to the fact that the iteration visits every value in the range of the function (except zero) exactly once before the pattern repeats.

M-sequences may be implemented in hardware using a Linear Feedback Shift Register (LFSR), arranged in Galois form for maximum speed, with careful selection of the feedback terms to produce a maximal length sequence. Standard tables of feedback terms for arbitrary length registers are readily available.

Scrambler 220 (FIG. 2) protects the contents of SDRAM memory by XOR-ing individual stored data values with a masking value. The mask is applied before the data value travels out across the untrusted memory bus to the SDRAM chip. The mask is removed after the masked data value has been retrieved from the SDRAM chip over the untrusted memory bus.

The masking value should have some desirable properties. It should be fast to calculate. This will allow every single memory transaction to be masked with no performance penalty. It should be different for every location in memory. This will cause a contiguous block of identical values to appear different from each other. It should be time-variant for any given location. This will cause identical data on the bus to appear different when snooped at different times. In this embodiment, the mask value is produced by a multi-stage SP-network, using M-sequences as a high-speed S-box, with an arbitrarily chosen P-box. The network operates fast enough for use on a 120 Mhz DDR memory bus.

The inputs to scrambler 220 are: a 22 bit memory bus address; a 256 bit (un)masked data value; and an 8 Kbit SRAM seed storage area. The output of scrambler 220 is: a 256 bit (un)masked data value. Note that due to the symmetric nature of the XOR masking operation, the roles of the 256 bit data value may be swapped between input and output. In other words, the input may be the masked value and the output the unmasked value, or vice versa.

A number of assumptions are made about the memory to be protected. These assumptions are shown in FIGS. 4A through 4D.

FIG. 4A depicts the layout of the entire SDRAM memory. Memory is assumed to be a 128 MB contiguous block, split into 64 equal areas (frame buffers) of 2 MB each. It is assumed that each area has a life cycle, transitioning from completely free to completely in-use and back to completely free again, each transition occurring atomically over the entire 2 MB area. For simplicity, it is assumed that the life cycle of each area is independent of the others, although no fundamental complications arise if this is not the case.

FIG. 4B depicts the layout of a single 2 MB frame buffer. Memory is assumed to be accessed across a 256 bit (32 byte) memory bus. This splits each 2 MB frame buffer into 65536 lines of 32 bytes each.

FIG. 4C depicts the layout of a single 32 byte line. Each line is split into a series of 16 stripes of 2 bytes each. As will be discussed, each stripe has a corresponding 16 bit M-sequence generator. For any given stripe, the same generator is used for all lines of all frame buffers.

FIG. 4D depicts the structure of a memory address. The assumptions in the preceding sections impose substructure on a memory address. The 128 MB memory space means the address is 27 bits. The top 6 bits identify 1 of 64 2 MB frame buffers in memory. The next 16 bits identify 1 of 65,536 32 byte lines in a buffer. The next 4 bits identify 1 of 16 2 byte stripes in a line. The final bit identifies 1 of 2 bytes in a stripe. The 256 bit memory bus means that the lower 5 bits are not used for memory accesses. Only the top 22 bits are sufficient to identify a 32 byte line in SDRAM for any given transaction.

FIG. 4E depicts the layout of an 8 Kbit SRAM on the FPGA which is assumed to be available. The SRAM is split into 64 areas of 128 bits each. Each one of the 64 128 bit values is used as a time-variant random seed for the generation of mask values for one of the 64 2 MB frame buffers. As long as a 2 MB frame buffer is in use, the corresponding mask value must remain constant. If it changes, the masked value will not be able to be demasked when read back from SDRAM. When a 2 MB frame buffer is free, the corresponding mask value may be changed. This provides a means of time variance for mask values at a single memory location. The mask value may change while a frame buffer is free, but not while it is in use.

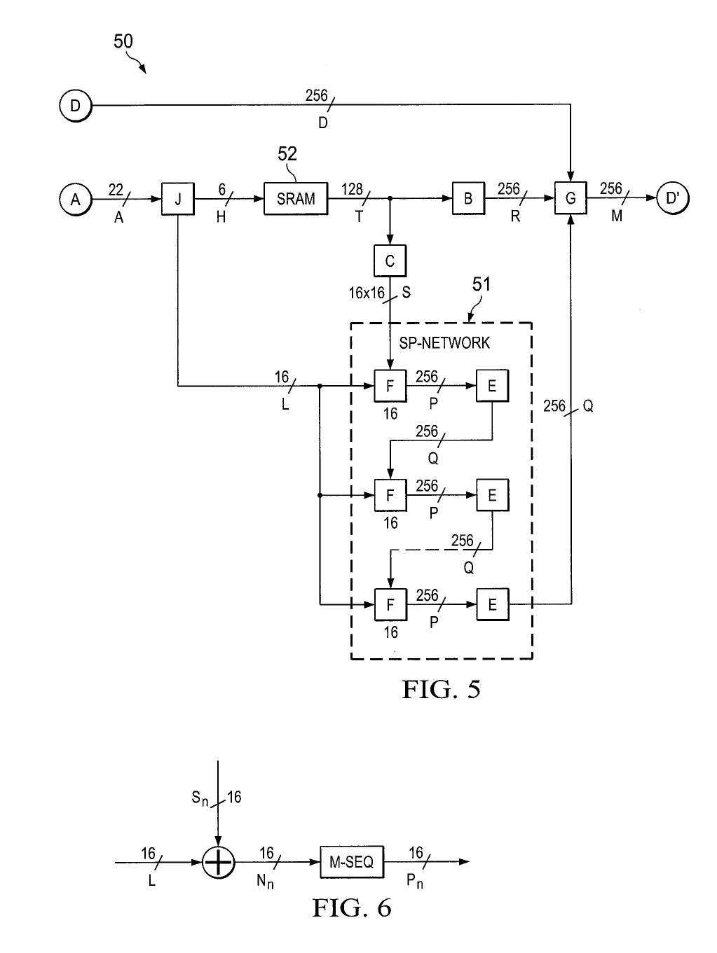

FIG. 5 illustrates one embodiment 50 of a secure memory scrambler diagram environment. Mask generation is accomplished using SP network 51. The 22 bit memory address is used, together with the contents of the SRAM seed area, to produce a 256 bit mask. This mask is XORed with the data before writing to and after reading from SDRAM.

The S-box structure is derived using M-sequences. Looked at from another perspective, an M-sequence generator maps the value zero onto itself, and maps every other value in the domain onto a different pseudo-random value. This concept is useful for implementing a high-speed substitution box by taking the input value as a point on the M-sequence cycle and take the output as the next adjacent point on the cycle. This mapping function can be implemented in hardware using only the feedback section of a Galois-form LFSR. The latch section of the LFSR can be omitted.

The following discussion describes three subsets of embodiment 50.

The first subset, signal D through signal M, inclusive, generates a time invariant, coarse grained location variant masking system.

The second subset, signal L through signal Q, inclusive, generates an optional addition to the system which provides fine grained location variance for the masking system.

The third subset, a modification of SRAM 52, generates an optional addition to the system which provides time variance for both the coarse and fine grained masking systems. Either or both extensions may be applied independently to the base masking system.

Coarse grained location variance masking is accomplished by the 256 bit input value D passed directly to the final stage G for masking or unmasking.

The 22 bit memory bus address A is passed to block J for partitioning. Partitioning occurs to produce signal H (6 bits) and signal L (16 bits) from signal A. Signal L is unused in the basic masking system, but later forms the basis of the fine grained location variant extension. The 6 bit signal H corresponds to bits 16:21 (signal L corresponds to bits 0:15) of the memory address signal A. Per FIG. 4D this identifies which of the 64 memory buffers is being addressed. It is used to select one of the 64 random seeds from the SRAM. Signal H provides the basis for coarse grained (per frame buffer) location variance in the mask value. SRAM 52 uses 6 bit signal H to index into a memory bank. It outputs 128 bit signal T, which is the random seed value for the frame buffer identified by signal H. SRAM 52 forms the basis of the time variant extension. In the time invariant base system, SRAM could be implemented as a ROM instead of a RAM. Signal T is a random value 128 bit signal stored in SRAM for the frame buffer identified by signal H. Signal T is used for the basic masking system. It is also used for a different purpose later by the fine grained location variance extension.

A permutation structure B is used to duplicate the 128 bit signal T to produce 256 bits. The 256 bits are randomly permuted to produce 256 bit signal R. The purpose of this is to provide a 256 bit coarse grained masking value for an entire frame buffer and can be used to help protect signal D.

Gate G is a 256 bit XOR operation and applies signal R to signal D, producing output signal M. Due to the symmetrical nature of XOR, D and M may play the role of masked and unmasked value interchangeably. Block G is modified in the location variant extension by adding fine grained signal Q into the masking process.

The 16 bit signal L corresponds to bits 0:15 of the memory address. Per FIG. 4D, this is used to identify which of the 65,536 lines in the selected memory buffer is being addressed. Signal L provides the basis for fine grained (per-line) location variance in the mask value.

Permutation element C accepts the 128 bit T signal T and duplicates it to produce the 256 bit S signal. The S signal bits are randomly partitioned into 16 groups of 16 bits each. Each 16 bit output is mixed into SP network cascade 51 for one of the 16 stripes. The purpose of block C is to move the fixed zero point of the M-sequence in each of the 16 stripes to a different random spot on its cyclic M-sequence. If this was not done, then when signal L is all zeros, signal Q would also be all zeros. In such an event, no fine-grained mask would be applied to any of the 16 stripes in line number 0. With block C in place, the all-zeros no-mask condition is moved to a different line number for each of the 16 stripes, increasing the quality of the final mask value by ensuring that at most one of the 16 stripes in any line remains unmasked. In the second and subsequent stages of the SP network cascade, the output signal Q of the previous stage fulfils the zero off setter role.

The 16×16 bit signal S is fed into each of the 16 F blocks in the first stage of the SP network. The purpose of this signal is to ensure that the fixed point at zero for the M-sequence in each F block occurs on a different line. This prevents line 0 from being forever unmasked due to the fixed point at zero in every m-sequence generator function.

FIG. 6 depicts one of the 16 F blocks in one of the stages in SP cascade 51. For each stage of SP cascade 51, FIG. 6 is duplicated 16 times, once per stripe in the line being masked. The purpose of this block is to introduce “confusion”, as discussed above and as well known. The zero-offset signal (S for first stage, Q for subsequent stages) is mixed with the location signal L. This value is used as the input to the M-SEQ function. The output of the M-SEQ function becomes signal P. M-sequence depicts the Galois-form feedback polynomial for a particular stripe.

The structure of all 16 F blocks in a stripe is the same, but M-SEQ is fixed to a different value for each stripe. This causes each of the 16 bit stripes in a line to take a different M-sequence path through the 16 bit space of the M-SEQ domain. All 16 stripes essentially take different pseudo-random paths through the space 1:65,535. Signal S ensures that the fixed point at zero for each stripe will occur on a different line. For any given stripe, the same feedback polynomial is used for all lines of all frame buffers. This polynomial is encoded in the connection pattern of various XOR gates in the feedback terms, and therefore cannot be changed.

The 256 bit signal P is the concatenated output of all 16 F blocks iii this stage of the SP network. It contains the “confusion”, and its purpose is to route that into the “diffusion” provided by block E. Block E performs an arbitrary 256 bit permutation. The purpose of this block is to introduce “diffusion”, as discussed above and as well known. Each stage in the SP network contains an identical block E. Block E mixes the bits from all 16 F blocks together, providing diffusion for the subsequent stages of the SP network.

The blocks F and E may be cascaded an arbitrary number of times, subject to resource usage and timing constraints. More levels of cascade produce more random-looking mask values, but introduce more timing delays within the 120 MHz bus timing window. Signal S is only routed to block F in the first stage. Only the signal Q from the final stage is routed to block G. In intermediate stages, signal S is replaced by signal Q from the previous stage. Signal L is identically routed to block F in all stages. The 256 bit signal Q is the final output of the SP network and comes from the output of block E in the final cascade stage. The purpose of signal Q is to inject a fine-grained location variance into the masking function in block G.

When a frame buffer is free (not in use), then the contents of SRAM for that frame buffer may be modified to create a time-variant signal T. This cascades through both the basic system and the fine grained location variance extension, providing a time variance.

Returning to FIG. 1, in operation when a user desires to “fast forward” it is not necessary to decompress every frame. In fact, it is not necessary to decode the Detail stream at all on fast forward (or fast-reverse) and it is only necessary to decompress the I frames of the Carrier signal. This is important because the GOP lengths of the Carrier stream and the Detail stream are on the order of perhaps 5 to one. There will be about a two second granularity in the seeking process, and then the merging process goes into a Carrier-only decompressing mode until the I frame of the carrier has been found and rendered. At the same time the system searches for the corresponding Detail stream for the beginning of the next DOP. Once that is found the system resumes the full decoding mode where both the Carrier and the Detail are decoded. The two streams are then matched, as discussed above, to present the final picture to the end user.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for rendering video data, said method comprising:
separating received video data into Carrier frame buffers and Detail frame buffers;
searching received Carrier frame buffers for timestamps;
searching received Detail frame buffers for time offsets; and
fusing received Detail frames into received Carrier frames by using received Detail frame time offsets and by removing any frame biasing added during encoding.

2. The method of claim 1 wherein said Carrier separating and Detail separating each comprises:
decompressing respective compressed Carrier and Detail streams received from a source; and
upscaling a decompressed Carrier stream to resize said Carrier stream to match a size of a decompressed Detail stream.

3. The method of claim 2 wherein said upscaling is accomplished in accordance with parameters sent with said compressed Carrier and Detail streams from said source.

4. The method of claim 2 further comprising:
decrypting said compressed Carrier and Detail streams prior to said decompressing.

5. The method of claim 2 wherein said decompressing and said fusing are controlled by a memory operating in communication over a bus with a data storage device, and wherein said bus communication is scrambled.

6. The method of claim 5 wherein said scrambled is controlled at least in part by a SP network.

7. A decoder for rendering a viewable image from a received compressed video data stream, said decoder comprising:
an extractor for separating said received compressed data into Carrier and Detail data streams;
compressors for independently decompressing said Carrier stream and said Detail stream;
resizing at least one of said decompressed streams such that said decompressed Carrier stream and said decompressed Detail stream have substantially matched sizes; and
merging said Carrier and Detail decompressed streams to form a user viewable image, said merging being controlled, at least in part, by timestamps associated with frames of said Carrier stream and timestamp offsets associated with said Detail stream, said viewable image having high fidelity with respect to a user's HVS.

8. The decoder of claim 7 wherein said compressed video data stream is received at said decoder in a format requiring less than 3 Mbits per second.

9. The decoder of claim 8 wherein said compressed video data stream is received at said decoder in encrypted format, and wherein said decoder further comprises:
means for decrypting said compressed video data prior to separating said Carrier and Detail streams.

10. A decoder for decompressing a video data stream, said decoder comprising:
a circuit for receiving a first data frame containing global parameters for controlling decompressing of video data contained in data frames other than said first data frames;
said circuit further operable for receiving a plurality of second data frames, each said created second data frame containing compressed video data pertaining to a first video data stream of a program, each said second data frame having at least one timestamp for indicating when a decompressed rendition of said first data stream video contained in said second data frame is to be presented to a viewer, said decompression of said data in each said second data frame controlled, at least in part, by said parameters contained in a related first data frame; and
said circuit further operable for receiving within each second data frame, in conjunction with said compressed first video data stream additional compressed video data of a second compressed video stream of said program, said additional compressed video data having a temporal relationship with said first video data stream;
decoders for decompressing said first and second video data streams in accordance with parameters provided by both said first and second data frames; and
a fuser for combining decoded ones of said first and second data streams into a user viewable image in accordance with respective timestamps of said first and second data streams, said viewable image having a proper temporal relationship between said video streams, said viewable image having high fidelity as observed by a HVS.

11. The decoder of claim 10 wherein said respective timestamps comprises:
a timestamp on each frame of said first video stream; and
a timestamp offset from each said timestamp on each frame of said second data stream.
